(19) United States
(12) Patent Application Publication
(10) Pub. No.: US 2005/0247419 A1
(43) Pub. Date: Nov. 10, 2005

(54) Treatment composition for making acquisition fluff pulp in sheet form

(76) Inventors: Othman A. Hamed, Jesup, GA (US); Michael Haeussler, Savannah, GA (US)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(21) Appl. No.: 10/839,715

(22) Filed: May 6, 2004

(51) Int. Cl. D06M 13/192; D21H 11/20; B01J 20/24; B01J 20/28; D06M 11/06

(52) U.S. Cl. 162/157.6; 162/9; 8/116.1; 604/378

(57) ABSTRACT

A treatment composition for producing acquisition fluff pulp, the treatment composition being a mixture of a cross-linking agent and a modifying agent. The cross-linking agent may be a polycarboxylic acid. The modifying agent may be a material that is water soluble non-anionic, non-polymeric material, and can function as debonder and plasticizer. A method of producing acquisition fluff pulp using the treatment composition involves treating a cellulosic base fiber with a treatment composition solution to impregnate the fiber with the treatment composition, and then drying and curing the impregnated fiber. The resultant acquisition fluff pulp may be utilized in an acquisition layer and/or an absorbent core of an absorbent article intended for body waste management.

### BACKGROUND OF THE INVENTION

1. Field of the Invention

Embodiments of the invention relate to a treatment composition for making acquisition fluff pulp in sheet form. The treatment composition comprises a mixture of a cross-linking agent and a modifying agent. Embodiments of the present invention also relate to a process of making the acquisition fluff pulp in sheet form using the treatment composition, and the resultant acquisition fluff pulp, which has excellent acquisition and distribution properties. The acquisition fluff pulp of the present invention can be characterized as having an improved acquisition rate, resiliency, bulk and absorbency under load. The acquisition fluff pulp also can be characterized as having low centrifuge retention capacity which make it suitable for use in absorbent articles intended for body fluid management.

2. Description of Related Art

Absorbent articles intended for personal care, such as adult incontinent pads, feminine care products, and infant diapers typically are comprised of at least a top sheet, a back sheet, an absorbent core positioned between the top sheet and back sheet, and an optional acquisition/distribution layer positioned between the top sheet and the absorbent core. The acquisition layer comprised of, for example, acquisition fibers, usually is incorporated in the absorbent articles to provide better distribution of liquid, increased rate of liquid absorption, reduced gel blocking, and improved surface dryness. A wide variety of acquisition fibers are known in the art. Included among these are synthetic fibers, a composite of cellulosic fibers and synthetic fibers, and cross-linked cellulosic fibers. Cross-linked cellulosic fiber is preferred because it is abundant, it is biodegradable, and it is relatively inexpensive.

Cross-linked cellulosic fibers and processes for making them have been described in the literature for many years (see, for example, G. C. Tesoro, Cross-Linking of Cellulosics, in Vol. II of Handbook of Fiber Science and Technology, pp. 1-46 (M. Lewin and S. B. Sello eds., Mercel Dekker, New York, 1983)). The cross-linked cellulosic fibers typically are prepared by reacting cellulose with polyfunctional agents that are capable of reacting with the hydroxyl groups of the anhydroglucose repeating units of the cellulose either in the same chain, or in neighboring chains simultaneously.

Cellulosic fibers typically are cross-linked in fluff form. Processes for making cross-linked fiber in fluff form comprise dipping swollen or non-swollen fiber in an aqueous solution of cross-linking agent, catalyst, and softener. The fiber so treated, then is usually cross-linked by heating it at elevated temperature in the swollen state, as described in U.S. Pat. No. 3,241,553, or in the collapsed state after defiberizing it, as described in U.S. Pat. No. 3,224,926, and European Patent No. 0,427,361 B1, the disclosures of each of which are incorporated by reference herein in their entirety.

Cross-linking of fibers is believed to improve the physical and the chemical properties of fibers in many ways, such as improving the resiliency (in the dry and wet state), increasing the absorbency, reducing wrinkling, and improving shrinkage resistance. However, cross-linked cellulosic fibers have not been widely adopted in absorbent products, seemingly because of the difficulty of successfully cross-linking cellulosic fibers in the sheet form. More specifically, it has been found that cross-linked fiber in the sheet form tends to become difficult to defiberize without causing substantial problems with the fibers. These problems include severe fiber breakage and increased amounts of knots and nits (hard fiber clumps). Furthermore, such cross-linked fibers demonstrate high unpleasant odor and low fiber brightness. These disadvantages render the cross-linked product completely unsuitable for many applications.

The difficulties of defiberizing cross-linked fiber in sheet form are believed to be attributable to two factors: (a) sheeted fibers in a dry state are in intimate contact with each other; and (b) the presence of pulping and bleaching residuals such as lignin and hemicellulose. Mechanical entanglement and hydrogen bonding of the sheeted fibers brings fibers into close contact. As a result, when fibers are treated with a cross-linking agent and are heated for curing, the fibers tend to form inter-fiber cross-links (between two adjacent fibers) rather than intra-fiber cross-links (chain to chain within a single fiber). Pulping and bleaching residuals such as lignin and hemicellulose, combine with the cross-linking agents under the heated conditions of the cross-linking reaction to form thermosetting adhesives. Thus, these residuals serve to adhesively bond adjacent fibers so that it is very difficult to separate them under any conditions without considerable fiber breakage. Because the cross-linked fibers tend to be brittle, the fibers themselves will often break, leaving the bonded areas between adjacent fibers intact.

There have been many proposed solutions to overcome some of the problems of cross-linking fiber in sheet form. One alleged solution to this problem is to minimize the contact between fibers in the dry state. For example, Graef et al. in U.S. Pat. No. 5,399,240, the disclosure of which is incorporated herein by reference in its entirety, describes a method of treating fiber in sheet form with a mixture of a cross-linking agent and a de-bonder. The de-bonder used for pulp treatment is usually composed of a fatty chain and quaternary ammonium group. The de-bonder tends to interfere with the hydrogen bonding between fibers and thus minimizes the contact between fibers in dry state. While in sheet form, the fiber is then cured at elevated temperatures. As a result, fibers are produced with a relatively low content of knots and nits. Unfortunately, the long hydrophobic alkane chain tends to have undesirable hydrophobic effects on fibers—resulting in decreased absorbency and wettability, rendering it unsuitable for applications such as in absorbent articles, where a high rate of absorbency and fast acquisition are required.

In U.S. Pat. No. 3,434,918, Bernardin et al. disclose a method of treating fibers in sheet form with a cross-linking agent and a catalyst. The treated sheet then is wet-aged to render the cross-linking agent insoluble. The wet-aged fibers are re-dispersed before curing, mixed with untreated fibers, sheeted and then cured. The mixture of cross-linked fibers and untreated fibers are potentially useful for making products such as filter media, tissues, and toweling where high bulk and good water absorbency are desired without excessive stiffness in the product. Unfortunately, the presence of untreated fibers make the produced fiber unsuitable as an acquisition layer in hygiene products such as diapers.

Other documents describing methods of treating fiber in sheet form include, for example, U.S. Pat. Nos. 4,204,054; 3,844,880; and 3,700,549 (the disclosures of each of which are incorporated by reference herein in their entirety). However, the above-described approaches complicate the process of cross-linking fiber in sheet form, and render the process time consuming, and costly. As a result, these processes result in cross-linked fibers with a substantial decrease in fiber performance, and a substantial increase in cost.

In previous work, (U.S. patent application Ser. No. 10/166,254, entitled: “Chemically Cross-Linked Cellulosic Fiber and Method of Making the Same,” filed on Jun. 11, 2002; and Ser. No. 09/832,634, entitled “Cross-Linked Pulp and Method of Making Same,” filed Apr. 10, 2001, and Ser. No. 10/387,485 entitled “Method For Making Chemically Cross-Linked Cellulosic Fiber In The Sheet Form,” filed Mar. 14, 2003) it was described that mercerized fiber and a mixture of mercerized and conventional fibers can be successfully cross-linked in sheet form. The produced cross-linked fiber showed similar or better performance characteristics than conventional individualized cross-linked cellulose fibers. Also, the produced fiber showed less discoloration and reduced amounts of knots and nits, when compared to conventional individualized cross-linked fiber.

Fiber mercerization, which is a treatment of fiber with an aqueous solution of sodium hydroxide (caustic), is one of the earliest known modifications of fiber. It was invented 150 years ago by John Mercer (see British Patent 1369, 1850). The process generally is used in the textile industry to improve cotton fabric's tensile strength, dyeability, and luster (see, for example, R. Freytag, J.-J. Donze, Chemical Processing of Fibers and Fabrics, Fundamental and Applications, Part A, in Vol. I of Handbook of Fiber Science and Technology, pp. 1-46 (M. Lewis and S. B. Sello eds., Mercell Decker, New York 1983)). However, the use of mercerized fiber to produce cross-linked fiber in sheet form is expensive when compared to the use of conventional non-mercerized fiber.

The description herein of certain advantages and disadvantages of known cellulosic fibers, treatment compositions, and methods of their preparation, is not intended to limit the scope of the present invention. Indeed, the present invention may include some or all of the methods, fibers and compositions described above without suffering from the same disadvantages.

### SUMMARY OF THE INVENTION

In view of the difficulties presented by cross-linking cellulosic fibers in the sheet form, there is a need for a simple, relatively inexpensive, treatment composition suitable for making acquisition fluff pulp in sheet form without sacrificing wettability of the fibers, whereby the resultant sheet can be defiberized into individual fibers without serious fiber breakage. The resultant sheet also preferably has low contents of knots and nits, and reduced odor and discoloration. There also exists a need for a process of making acquisition fluff pulp in the sheet form that provides time and cost savings to both the fiber manufacturer and the manufacturer of absorbent articles. The present invention desires to fulfill these needs and to provide further related advantages.

It is therefore a feature of an embodiment of the invention to provide a treatment composition to be used in making acquisition fluff pulp in sheet form. The treatment composition comprises a mixture of a cross-linking agent and a modifying agent. In one embodiment of the present invention, the cross-linking agent and the modifying agent are mixed in a weight ratio of about 1:1 to about 6:1 of cross-linking agent to modifying agent. In various embodiments of the invention, the cross-linking agent is a polycarboxylic acid. In other embodiments, the cross-linking agent is an aldehyde. In yet other embodiments, the cross-linking agent is a urea-based derivative. In various embodiments of the invention, the modifying agent is a polyhydroxy compound containing a hydrophobic alkyl group, or an ester- or ether-derivative of such a polyhydroxy compound, where the hydrophobic alkyl group is an alkyl with 3 or more carbon atoms comprised of saturated, unsaturated (alkenyl, alkynyl, allyl), substituted, unsubstituted, branched or unbranched, cyclic, or acyclic compounds.

It also is a feature of an embodiment of the present invention to provide a method for making acquisition fluff pulp, where the method involves providing a treatment composition solution that comprises the treatment composition described above, providing a cellulosic base fiber, and applying the treatment composition solution to the cellulosic base fiber to impregnate the fiber with the treatment composition, and thereafter drying and curing the impregnated cellulosic fiber to form intra-fiber bonds.

It also is a feature of an embodiment of the present invention to provide an acquisition fluff pulp made by the above-described method. It also is a feature of an embodiment of the present invention to provide an absorbent article comprising the acquisition fluff pulp.

These and other objects, features and advantages of the present invention will appear more fully from the following detailed description of the preferred embodiments of the invention, and the attached drawings.

### DETAILED DESCRIPTION OF PREFERRED EMBODIMENTS

The present invention is directed to acquisition fluff pulp in the sheet form and to a method of making the acquisition fluff pulp. The method comprises treating the cellulosic fibers in sheet or roll form with an aqueous solution of a treatment composition.

As used herein, the terms “absorbent garment,” “absorbent article” or simply “article” or “garment” refer to mechanisms that absorb and contain body fluids and other body exudates. More specifically, these terms refer to garments that are placed against or in proximity to the body of a wearer to absorb and contain the various exudates discharged from the body. A non-exhaustive list of examples of absorbent garments includes diapers, diaper covers, disposable diapers, training pants, feminine hygiene products and adult incontinence products. Such garments may be intended to be discarded or partially discarded after a single use (“disposable” garments). Such garments may comprise essentially a single inseparable structure (“unitary” garments), or they may comprise replaceable inserts or other interchangeable parts.

Embodiments of the present invention may be used with all of the foregoing classes of absorbent garments, without limitation, whether disposable or otherwise. Some of the embodiments described herein provide, as an exemplary structure, a diaper for an infant, however this is not intended to limit the claimed invention. The invention will be understood to encompass, without limitation, all classes and types of absorbent garments, including those described herein.

The term “component” can refer, but is not limited, to designated selected regions, such as edges, corners, sides or the like; structural members, such as elastic strips, absorbent pads, stretchable layers or panels, layers of material, or the like.

Throughout this description, the term “disposed” and the expressions “disposed on,” “disposed above,” “disposed below,” “disposing on,” “disposed in,” “disposed between” and variations thereof are intended to mean that one element can be integral with another element, or that one element can be a separate structure bonded to or placed with or placed near another element. Thus, a component that is “disposed on” an element of the absorbent garment can be formed or applied directly or indirectly to a surface of the element, formed or applied between layers of a multiple layer element, formed or applied to a substrate that is placed with or near the element, formed or applied within a layer of the element or another substrate, or other variations or combinations thereof.

Throughout this description, the terms “top sheet” and “back sheet” denote the relationship of these materials or layers with respect to the absorbent core. It is understood that additional layers may be present between the absorbent core and the top sheet and back sheet, and that additional layers and other materials may be present on the side opposite the absorbent core from either the top sheet or the back sheet.

Throughout this description, the expressions “upper layer,” “lower layer,” “above” and “below,” which refer to the various components included in the absorbent material are used to describe the spatial relationship between the respective components. The upper layer or component “above” the other component need not always remain vertically above the core or component, and the lower layer or component “below” the other component need not always remain vertically below the core or component. Other configurations are contemplated within the context of the present invention.

Throughout this description, the term “impregnated” insofar as it relates to a treatment composition impregnated in a fiber, denotes an intimate mixture of treatment composition and cellulosic fiber, whereby the treatment composition may be adhered to the fibers, adsorbed on the surface of the fibers, or linked via chemical, hydrogen or other bonding (e.g., Van der Waals forces) to the fibers. Impregnated in the context of the present invention does not necessarily mean that the treatment composition is physically disposed beneath the surface of the fibers.

The present invention concerns acquisition fluff pulp that is useful in absorbent articles, and in particular, that is useful in forming acquisition/distribution layers or absorbent cores in the absorbent article. The particular construction of the absorbent article is not critical to the present invention, and any absorbent article can benefit from this invention. Suitable absorbent garments are described, for example, in U.S. Pat. Nos. 5,281,207, and 6,068,620, the disclosures of each of which are incorporated by reference herein in their entirety including their respective drawings. Those skilled in the art will be capable of utilizing acquisition fluff pulp of the present invention in absorbent garments, cores, acquisition layers, and the like, using the guidelines provided herein.

In accordance with embodiments of the present invention, the treatment composition that is useful in making acquisition fluff pulp in sheet form is made by mixing a cross-linking agent and a modifying agent. The treatment composition of the present invention may be prepared by any suitable and convenient procedure. The cross-linking agent and the modifying agent are generally mixed in a weight ratio of cross-linking agent to modifying agent of about 1:1 to about 6:1. Preferably, the treatment composition is present in an aqueous solution, diluted with water to a predetermined concentration.

Suitable cross-linking agents for use in the treatment composition of the present invention include aliphatic and alicyclic polycarboxylic acids containing at least two carboxylic acid groups. The aliphatic and alicyclic polycarboxylic acids could be either saturated or unsaturated, and they might also contain other heteroatoms such as sulfur, nitrogen or halogen. Examples of suitable polycarboxylic acids include: 1,2,3,4-butanetetracarboxylic acid, 1,2,3-propanetricarboxylic acid, oxydisuccinic acid, citric acid, itaconic acid, maleic acid, tartaric acid, glutaric acid, iminodiacetic acid, citraconic acid, tartrate monosuccinic acid, benzene hexacarboxylic acid, cyclohexanehexacarboxylic acid, maleic acid, and any combinations or mixtures thereof.

Other suitable crosslinking agents for use in the present invention include polymeric polycarboxylic acids, such as those formed from monomers and/or co-monomers that include carboxylic acid groups or functional groups that can be converted into carboxylic acid groups. Such monomers include, for example, acrylic acid, vinyl acetate, maleic acid, maleic anhydride, carboxy ethyl acrylate, itanoic acid, fumaric acid, methacrylic acid, crotonic acid, aconitic acid, tartrate monosuccinic acid, acrylic acid ester, methacrylic acid ester, acrylic amide, methacrylic amide, butadiene, styrene, or any combinations or mixtures thereof.

Examples of suitable polymeric polycarboxylic acids include polyacrylic acid and polyacrylic acid copolymers such as, for example, poly(acrylamide-co-acrylic acid), poly(acrylic acid-co-maleic acid), poly(ethylene-co-acrylic acid), and poly(1-vinylpyrolidone-co-acrylic acid), as well as other polyacrylic acid derivatives such as poly(ethylene-co-methacrylic acid) and poly(methyl methacrylate-co-methacrylic acid). Other examples of suitable polymeric polycarboxylic acids include polymeric acid and polymaleic acid copolymers such as, for example, poly(methyl vinyl ether-co-maleic acid), poly(styrene-co-maleic acid), and poly(vinyl chloride-co-vinyl acetate-co-maleic acid). The representative polycarboxylic acid copolymers noted above are commercially available in various molecular weights and ranges of molecular weights.

Other cross-linking agents suitable for use in the present invention include aldehydes, and urea-based derivatives. Suitable aldehyde cross-linking agents include, for example, formaldehyde, glyoxal, glutaraldehyde, and glyceraldehydes. Suitable urea-based derivatives for use in the present invention include, for example, urea based-formaldehyde addition products, methylolated ureas, methylolated cyclic ureas, methylolated lower alkyl cyclic ureas, methylolated dihydroxy cyclic ureas, dihydroxy cyclic ureas, and lower alkyl substituted cyclic ureas. Especially preferred urea-based crosslinking agents include dimethyldihydroxy urea (DMDHU, or 1,3-dimethyl-4,5-dihydroxy-2-imidazolidinone), dimethyloldihydroxyethylene urea (DMDHEU, or 1,3-dihydroxymethyl-4,5-dihydroxy-2-imidazolidinone), dimethylol urea (DMU, or bis[N-hydroxymethyl]urea), dihydroxyethylene urea (DHEU, or 4,5-dihydroxy-2-imidazolidinone), dimethylolethylene urea (DMEU, or 1,3-dihydroxymethyl-2-imidazolidinone), and dimethyldihydroxyethylene urea (DDI, or 4,5-dihydroxy-1,3-dimethyl-2-imidazolidinone). Other suitable substituted ureas include glyoxal adducts of ureas, polyhydroxyalkyl urea disclosed in U.S. Pat. No. 6,290,867, hydroxyalkyl urea, and β-hydroxyalkyl amide disclosed in U.S. Pat. No. 5,965,466.

Alternately, a cross-linking agent suitable for use in the present invention may be comprised of any combination or mixture of two or more of the above mentioned cross-linking agents.

The term “modifying agent” as used herein refers to a material that may be water-soluble, non-anionic, non-polymeric, and can function as a debonder and plasticizer. Examples of suitable modifying agents for use in the treatment composition of the present invention include polyhydroxy compounds containing a hydrophobic alkyl group, and the ether- and ester-derivatives of the polyhydroxy compounds. Preferably, the hydrophobic alkyl group is an alkyl with 3 or more carbon atoms, including saturated, unsaturated (e.g., alkenyl, alkynyl, allyl), substituted, un-substituted, branched and un-branched, cyclic, and acyclic compounds. Examples of such modifying agents include, but are not limited to: cis- and trans-1,4-cyclohexanedimethanol, diacetin, triacetin, tri(propylene glycol), di(propylene glycol), tri(propylene glycol) methyl ether, tri(propylene glycol) butyl ether, tri(propylene glycol) propyl ether, di(propylene glycol) methyl ether, di(propylene glycol) butyl ether, di(propylene glycol) propyl ether, di(propylene glycol) dimethyl ether, 2-phenoxyethanol, propylene carbonate, propylene glycol diacetate, and combinations and mixtures thereof. Other suitable modifying agents for use in the present invention include the alkyl ethers and alkyl acid esters of citric acid. Preferred modifying agents for use in the present invention include cyclohexanedimethanol, tri(propylene glycol) methyl ether, and tri(propylene glycol) propyl ether.

The inventors have unexpectedly discovered that 1,4-cyclohexanedimethanol (CHDM) is an effective modifying agent for the use in the cross-linking of wood pulp in sheet form with a polycarboxylic acid cross-linking agent to create acquisition fluff pulp. 1,4-Cyclohexanedimethanol is water soluble, and has a melting point of about 46° C. It is widely used as plasticizer in resins, in powder coating, and as a solvent for cosmetic and personal care products. When used as a modifying agent, CHDM is believed to function as a plasticizer, enhancing the fluffing properties of the pulp fibers by reducing the formation of knots and nits. Without being limited to a specific theory, CDHM molecules appear to act as “wedges” that reduce the inter-fiber hydrogen bonding and increase the bulkiness of the fluff pulp. (See K. D. Sears, et al., Vol. 27 of Journal of Applied Polymer Science, pp. 4599-4610 (1982)). In addition, the 1,4-cyclohexanedimethanol has been found to have no adverse effect on the acquisition properties of the acquisition fluff pulp of the present invention.

Another aspect of the present invention provides a method for making acquisition fluff pulp using the treatment composition of the present invention. The process preferably comprises treating cellulosic base fibers in sheet or roll form with an aqueous treatment composition solution to impregnate the cellulosic base fiber, followed by drying and curing the impregnated fiber at sufficient temperature and for a sufficient period of time to accelerate formation of covalent bonding between hydroxyl groups of cellulosic fibers and functional groups of the treatment composition.

The treatment composition solution is an aqueous solution comprising the treatment composition of the present invention. The treatment composition solution may be prepared by any suitable and convenient procedure. Preferably the treatment composition is present in the solution in a concentration of about 3.5 weight % to about 7.0 weight %, based on the total weight of the solution. Preferably the treatment composition is diluted to a concentration sufficient to provide from about 0.5 weight % to about 10.0 weight % of treatment composition on fiber, more preferably from about 2.0 weight % to about 7.0 weight %, and most preferably from about 3.0 weight % to about 6.0 weight %. By way of example, 7 weight % treatment composition is equal to 7 grams of treatment composition per 100 grams oven dried fiber. Preferably, the pH of the treatment composition solution is adjusted to from about 1 to about 5, more preferably from about 1.5 to about 3.5. The pH can be adjusted using alkaline solutions such as, for example, sodium hydroxide or sodium carbonate.

Optionally, the treatment composition solution may include a catalyst to accelerate the reaction between hydroxyl groups of cellulose and carboxyl groups of the cross-linking agent of the treatment composition of present invention. Any catalyst known in the art to accelerate the formation of an ester bond between hydroxyl group and acid group may be used. Suitable catalysts for use in the present invention include alkali metal salts of phosphorous containing acids such as alkali metal hypophosphites, alkali metal phosphites, alkali metal polyphosphonates, alkali metal phosphates, and alkali metal sulfonates. A particularly preferred catalyst is sodium hypophosphite. The catalyst can be applied to the fiber as a mixture with the treatment composition, before the addition of the treatment composition, or after the addition of treatment composition to the cellulosic fiber. A suitable weight ratio of catalyst to treatment composition is, for example from about 1:1 to about 1:10, and preferably from about 1:3 to about 1:6.

Optionally, the treatment composition solution may include other additives such as, for example, brighteners, odor absorbents and flame retardants. Examples of suitable flame retardant additives include, for example, sodium phosphate, ammonium hydrogen phosphate, boric acid, calcium chloride, ammonium sulfate, sodium bisulfate, sodium tetraborate decahydrate, sodium hydrogen phosphate, and ammonium carbonate. A preferred fire retardant additive is sodium tetraborate tetrahydrate, which has been found to produce acquisition fibers with less discoloration (yellowing) and burning odor. Preferably, the ratio of flame retardant to treatment composition is about 0.1:6 to about 2:6, and preferably from about 0.5:6 to about 1:6. The flame retardant additive can be applied to the fiber with the treatment composition. Alternately, the flame retardant may be applied to the fiber separately, either before or after the addition of the treatment composition to the cellulosic fibers.

Optionally, in addition to the treatment composition solution, other finishing agents such as softening, and wetting agents also may be applied to the cellulosic base fiber. Examples of softening agents include fatty alcohols, fatty acids amides, polyglycol ethers, fatty alcohols sulfonates, and N-stearyl-urea compounds. Examples of wetting agents include fatty amines, salts of alkylnapthalenesulfonic acids, alkali metal salts of dioctyl sulfosuccinate, and the like.

The cellulosic base fiber may be any conventional or other cellulosic fiber, so long as it capable of providing the desired physical characteristics. Suitable cellulosic fiber for use in forming the acquisition fluff pulp of the present invention includes that primarily derived from wood pulp. Suitable wood pulp can be obtained from any of the conventional chemical processes, such as the Kraft and sulfite processes. Preferred fiber is that obtained from various soft wood pulp such as Southern pine, White pine, Caribbean pine, Western hemlock, various spruces, (e.g. Sitka Spruce), Douglas fir or mixtures and combinations thereof. Fiber obtained from hardwood pulp sources, such as gum, maple, oak, eucalyptus, poplar, beech, and aspen, or mixtures and combinations thereof also can be used in the present invention. Other cellulosic fiber derived from cotton linter, bagasse, kemp, flax, and grass also may be used in the present invention. The cellulosic base fiber can be comprised of a mixture of two or more of the foregoing cellulosic pulp products. Particularly preferred fibers for use in forming the acquisition fluff pulp of the present invention are those derived from wood pulp prepared by the Kraft and sulfite-pulping processes. In addition, the cellulosic base fiber may be non-bleached, partially bleached or fully bleached cellulosic fiber.

The cellulosic base fibers can be provided in any of a variety of forms. For example, one aspect of the present invention contemplates using cellulosic base fibers in sheet, roll, or fluff form. In another aspect of the invention, the fiber can be provided in a mat of non-woven material. Fibers in mat form are not necessarily rolled up in a roll form, and typically have a density lower than fibers in sheet form. In yet another feature of an embodiment of the invention, the cellulosic base fiber is provided in a wet or dry state. It is preferred that the cellulosic base fibers be provided in a dry state.

The cellulosic base fiber that is treated in accordance with various embodiments of the present invention while in the sheet form can be any of wood pulp fibers or fiber from any other source described previously. In one embodiment of the invention, fibers in the sheet form suitable for use in the present invention include caustic-treated fibers. In addition to the advantages discussed previously, treatment of fibers with caustic is believed to add several other advantages to the fibers. Among these are: (1) caustic treated fibers have high α-cellulose content, since caustic removes residuals such as lignin and hemicellulose left on the fibers from pulping and bleaching processes; (2) caustic treated fibers have a round, circular shape (rather than the flat, ribbon-like shape of conventional fibers) that reduces the contact and weakens the hydrogen-bonding among fibers in the sheet form; and (3) caustic treatment converts cellulose chains from their native structure form, cellulose I, to a more thermodynamically-stable and less crystalline form, cellulose II. The cellulosic chains in cellulose II are found to have an anti-parallel orientation rather than parallel orientation as in cellulose I (see, for example, R. H. Atalla, Vol. III of Comprehensive Natural Products Chemistry, Carbohydrates And Their Derivatives Including Tannins, Cellulose, and Related Lignins, pp. 529-598 (D. Barton and K. Nakanishi eds., Elsevier Science, Ltd., Oxford, U.K. 1999)). Without wishing to be bound by theory, the above-mentioned properties of caustic treated fibers are believed to be one of the reasons behind the reduced amounts of fines, knots and nits that the inventors have found exist in mercerized fiber cross-linked in the sheet form, in accordance with embodiments of the invention.

A description of the caustic extraction process can be found in Vol. V, Part 1 of Cellulose and Cellulose Derivatives, (Ott, Spurlin, and Grafllin, eds., Interscience Publisher 1954). Briefly, the cold caustic treatment is carried out at a temperature less than about 65° C., but preferably at a temperature less than 50° C., and more preferably at a temperature between about 10° C. to 40° C. A preferred alkali metal salt solution is a sodium hydroxide solution either newly made up or as a solution by-product from a pulp or paper mill operation, e.g., hemicaustic white liquor, oxidized white liquor and the like. Other alkali metals such as ammonium hydroxide and potassium hydroxide and the like may be employed. However, from a cost standpoint, the preferred alkali metal salt is sodium hydroxide. The concentration of alkali metal salts in solution is typically in a range from about 2 to about 25 weight percent of the solution, preferably from about 3 to about 18 weight percent.

In one embodiment of the present invention, the cellulosic base fiber is a caustic-treated fiber that has been prepared by treating a liquid suspension of pulp at a temperature of from about 5° C. to about 85° C. with an aqueous alkali metal salt solution for a period of time ranging form about 5 minutes to about 60 minutes. In this embodiment, the aqueous metal salt solution has an alkali metal salt solution concentration of about 2 weight % to about 25 weight %, based on the total weight of the solution.

Commercially available caustic extractive pulp suitable for use in embodiments of the present invention include, for example, Porosanier-J-HP, available from Rayonier Performance Fibers Division (Jesup, Ga.), and Buckeye's HPZ products, available from Buckeye Technologies (Perry, Fla.).

Any method of applying the treatment composition solution to the fiber may be used, so long as it is capable of providing an effective amount of treatment composition to the fiber to produce the acquisition fluff pulp described herein. Preferably, the application method provides about 10% to about 150% by weight of solution to the fiber, based on the total weight of the fiber. Acceptable methods of application include, for example, spraying, dipping, impregnation, and the like. Preferably, the fiber is impregnated with the aqueous treatment composition solution. Impregnation typically creates a uniform distribution of treatment composition on the sheet and provides better penetration of treatment composition into the interior part of the fiber. Preferably, the treatment composition solution is applied to the cellulosic fiber to provide about 2% to about 7% by weight, and more preferably about 3% to about 6% of treatment composition on fiber, based on the total weight of the fiber. (By way of example, 7 weight % treatment composition is equal to 7 grams of treatment composition per 100 grams oven dried fiber.)

In one embodiment of the invention, a sheet of caustic treated fibers or conventional fibers in roll form is conveyed through a treatment zone where the treatment composition is applied on both surfaces by conventional methods such as spraying, rolling, dipping, knife-coating or any other manner of impregnation. A preferred method of applying the treatment composition solution to the fiber in roll form is by puddle press, size press, or blade coater.

In one embodiment of the present invention, the fiber in sheet or roll form, after having been treated with a solution of the treatment composition, then is preferably transported by a conveying device such as a belt or a series of driven rollers though a two-zone oven for drying and curing.

Fiber in fluff, roll, or sheet form after treatment with the solution of the treatment composition preferably is dried and cured in a two-stage process, and more preferably dried and cured in a one-stage process. Such drying and curing removes water from the fiber, thereupon inducing the formation of an ester linkage between hydroxyl groups of the cellulosic fibers and cross-linking agent. Any curing temperature and time can be used so long as they produce the desired effects described herein. Using the present disclosure, persons having ordinary skill in the art can determine suitable drying and curing temperatures and times, depending on the type of fiber, the type of treatment of the fiber, and the desired bonding density of the fiber.

Curing typically is carried out in a forced draft oven preferably from about 130° C. to about 225° C. (about 265° F. to about 435° F.), and more preferably from about 160° C. to about 220° C. (about 320° F. to about 430° F.), and most preferably from about 180° C. to about 215° C. (about 350° F. to about 420° F.). Curing is preferably carried out for a sufficient period of time to permit complete fiber drying and efficient bonding between cellulosic fibers and the treatment composition. Preferably, the fiber is cured from about 1 min to about 25 min, more preferably from about 7 min to about 20 min, and most preferably from about 10 min to about 15 min.

It is preferred that the cellulosic fiber is cured and dried in a one-step process, for a period of time ranging from about 3 minutes to about 15 minutes at temperatures within the range of 130° C. to about 225° C. Alternately, the drying and curing may be conducted in a two-step process. In this case, the drying step dries the impregnated cellulosic fiber, and the dried cellulosic fiber then is cured to form intra-fiber bonds. In one embodiment where the curing and drying are carried out in a two-step process, the drying step is carried out at a temperature below the curing temperature (e.g., between room temperature and about 130° C.) before the curing step. The curing step is then carried out, for example, for about 1 to 10 minutes at a temperatures within the range of 150° C. to about 225° C. Alternately, the curing step may be carried out for about 0.5 minutes to about 5 minutes at a temperature range of about 130° C. to about 225° C.

In the case where the cross-linking is carried out on fiber in fluff form, preferably the fiber is treated initially with the treatment composition of the present invention while in roll or sheet form, dried at a temperature below curing temperature, defiberized by passing it through a hammermill or the like, and then heated at elevated temperatures to promote intra-fiber bond formation between fibers and the treatment composition. In an alternate embodiment of the present invention, the cellulosic base fibers may be treated with the treatment composition while in fluff form and then dried and cured according to any of the methods described herein.

When the cellulosic base fibers are in roll or sheet form, it is preferred that after the treatment composition solution is applied, the fiber is dried and then cured, and more preferably is dried and cured in one procedure. In one feature of an embodiment of the present invention, the fiber in sheet or roll form after having been treated with the treatment composition solution, is transported by a conveying device such as a belt or series of driven rollers, through a two-zone oven for drying and curing. Alternately, the fiber is conveyed to a one-zone oven for a one step procedure for drying and curing. In another feature of an embodiment of the present invention, fiber in sheet form, after having been treated with the treatment composition solution, preferably is transported by a conveying device such as a belt or a series of driven rollers through a one-zone oven for drying, then to a hammermill for defiberization. The defiberized pulp produced by the hammermill then preferably is conveyed through a one-zone oven for curing. In another feature of an embodiment of the present invention, the defiberized pulp produced by the hammermill is airlaid into a non-woven mat, and then preferably is conveyed through a one-zone oven for curing.

While not intending to being limited by theory of operation, curing the treated cellulosic fibers results in the formation of intra-fiber ester links between the hydroxyl groups of the cellulosic fibers and the acid groups of the treatment composition. The ester links can form between the hydroxyl groups of the same chain or between hydroxyl groups of closely located cellulosic chains. The reaction mechanism between hydroxyl groups of the cellulosic fibers and the treatment composition is expected to be similar to that between cellulose and conventional cross-linking agents such as, for example, alkane polycarboxylic acids. The mechanism of cross-linking cellulose with polycarboxylic acid has been described by Zhou et al., Vol. 58 of Journal of Applied Polymer Science, pp. 1523-1524 (1995) and by Lees, M. J., Vol. 90 (3) of The Journal of Textile Institute, pp. 42-49 (1999). The mechanism of polycarboxylic acid cross-linking of cellulose is believed to occur via four steps: (1) formation of a 5- or 6-membered anhydride ring from polycarboxylic acid; (2) reaction of the anhydride with a cellulose hydroxyl group to form an ester bond and link the polycarboxylic acid to cellulose; (3) formation of an additional 5- or 6-membered ring anhydride from polycarboxylic acids pendant carboxyl groups; and (4) reaction of the anhydride with free cellulose hydroxyl groups to form ester cross-links.

The modifying agent, such as 1,4-CHDM, used in the present invention contains hydroxyl groups that, at high temperature, react with the polycarboxylic acid cross-linking agent to form a condensation product. The produced condensation product can react with the hydroxyl groups of the cellulosic fiber to form ester cross-links, like the cross-links formed by the conventional polycarboxylic acid cross-linking agents. As a result, a large portion of the modifying agent becomes part of the cross-links and is therefore non-extractable.

A representative structure of a reaction product formed from the condensation reaction between the modifying agent and a cross-linking agent during curing is shown below. Scheme 1 shows the condensation reaction of a citric acid cross-linking agent with a 1,4-cyclohexanedimethanol modifying agent during the curing process.

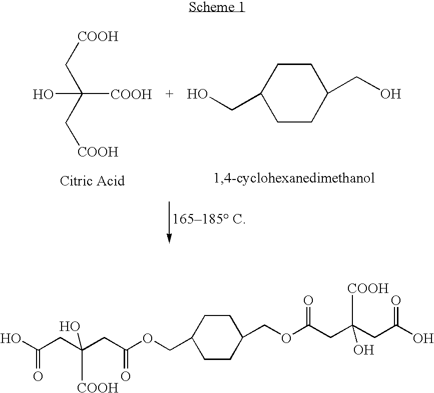

The cellulosic fibers modified in accordance with embodiments of the present invention preferably possess characteristics that are desirable in absorbent articles. For example, the acquisition fluff pulp preferably has a centrifuge retention capacity of less than about 0.6 grams of synthetic saline per gram of oven dried (OD) fibers (hereinafter “g/g OD”). The acquisition fluff pulp also has other desirable properties, such as absorbent capacity of greater than about 8.0 g/g OD, an absorbency under load of greater than about 7.0 g/g OD, less than about 10.0% of fines, and an acquisition rate upon the third insult (or third insult strikethrough) of less than about 11.0 seconds. The particular characteristics of the cellulosic based acquisition fiber of the invention are determined in accordance with the procedures described in more detail in the examples.

The centrifuge retention capacity measures the ability of the fiber to retain fluid against a centrifugal force. It is preferred that the acquisition fluff pulp of the invention have a centrifuge retention capacity of less than about 0.6 g/g OD, more preferably, less than about 0.55 g/g OD. The acquisition fluff pulp of the present invention can have a centrifuge retention capacity as low as about 0.50 g/g.

The absorbent capacity measures the ability of the fiber to absorb fluid without being subjected to a confining or restraining pressure. The absorbent capacity preferably is determined by the absorbency test method described herein. It is preferred that the acquisition fluff pulp of the invention have an absorbent capacity of more than about 8.0 g/g OD, more preferably, greater than about 9.0 g/g OD, even more preferably greater than about 10.0 g/g OD, and most preferably greater than about 11.0 g/g OD. The acquisition fluff pulp of the present invention can have an absorbent capacity as high as about 14.0 g/g OD.

The absorbency under load measures the ability of the fiber to absorb fluid against a restraining or confining force over a given period of time. It is preferred that the acquisition fluff pulp of the invention has an absorbency under load of greater than about 7.0 g/g OD, more preferably, greater than about 8.5 g/g OD, and most preferably, greater than about 9.0 g/g OD. The acquisition fluff pulp of the present invention can have absorbency under load as high as about 12.0 g/g OD.

The third insult strikethrough measures the ability of the fiber to acquire fluid, and is measured in terms of seconds. It is preferred that the acquisition fluff pulp of the invention has a third insult strikethrough for absorbing 9.0 mL of 0.9% saline of less than about 11.0 seconds, more preferably, less than about 10.0 seconds, even more preferably less than 8.0 seconds, and most preferably less than about 7.0 seconds. The acquisition fluff pulp of the present invention can have a third insult strikethrough of as low as about 6.0 seconds.

It also is preferred in the present invention, that the acquisition fluff pulp has a dry bulk of at least about 8.0 cm³/g fiber, more preferably at least about 9.0 cm³/g fiber, even more preferably at least about 10.0 cm³/g fiber, and most preferably at least about 11.0 cm³/g fiber.

In addition to being more economical, there are several other advantages for making acquisition fluff pulp from conventional cellulosic fibers in sheet form. Fibers cross-linked in sheet form have typically been expected to have an increased potential for inter-fiber cross-linking which leads to “knots” and “nits” resulting in poor performance in some applications. For instance, when a standard purity fluff pulp, Rayfloc®-J-LD, is cross-linked in sheet form with conventional cross-linking agents such as, for example, citric acid, the “knot” content increases substantially, indicating increased deleterious inter-fiber bonding (see Table 2). In contrast, the acquisition fluff pulp of the present invention preferably has less than about 30% of knots and nits, more preferably less than about 25% knots and nits, even more preferably less than about 15% knots and nits, and most preferably less than about 10% knots and nits. The acquisition fluff pulp of the present invention also preferably has less than about 10.0% of fines, preferably less than about 8.0% fines, and most preferably, less than about 7.0% fines. The acquisition fluff pulp of the present invention also preferably has more than about 75% accepts.

Another advantage of using the treatment composition of the present invention to make acquisition fluff pulp in fluff or sheet form is that the resultant fiber is more stable to color reversion at elevated temperature. Converting cellulosic fibers into acquisition fluff pulp requires high processing temperatures (typically around 195° C. for 10-15 minutes), which can lead to substantial discoloration with the conventional cross-linking agent(s). By using the treatment composition of the present invention, this discoloration is less likely to occur. Preferably, the treated acquisition fluff pulp has an ISO Brightness of greater than about 75%, when measured according to the test method provided herein.

Another benefit of the present invention is that the acquisition fluff pulp made in accordance with the present invention in sheet form enjoys the same or better performance characteristics as conventional individualized cross-linked cellulose fibers, but avoids the processing problems associated with dusty individualized cross-linked fibers.

The properties of the acquisition fluff pulp prepared in accordance with the present invention make the fiber suitable for use, for example, as a bulking material, in the manufacturing of high bulk specialty fiber that requires good absorbency and porosity. The acquisition fluff pulp can be used, for example, in non-woven, fluff absorbent products. The acquisition fluff pulp may also be used independently, or preferably incorporated with other cellulosic fibers to form blends using conventional techniques, such as air laying techniques. In an airlaid process, the acquisition fluff pulp of the present invention alone or in combination with other fibers is blown onto a forming screen or drawn onto the screen via a vacuum. Wet laid processes may also be used, combining the acquisition fluff pulp of the invention with other cellulosic fibers to form sheets or webs of blends.

The acquisition fluff pulp of the present invention may be incorporated into various absorbent articles, preferably intended for body waste management such as adult incontinent pads, feminine care products, and infant diapers. The acquisition fluff pulp can be used as an acquisition layer in the absorbent articles, and it can be utilized in the absorbent core of the absorbent articles. Towels and wipes and other absorbent products such as filters also may be made with the acquisition fluff pulp of the present invention. Accordingly, an additional feature of the present invention is to provide an absorbent article and an absorbent core that includes the acquisition fluff pulp of the present invention.

In accordance with various embodiments of the present invention, the acquisition fluff pulp was incorporated into an acquisition layer of an absorbent article, and the acquisition time of the fiber in the absorbent article was evaluated by the Specific Absorption Rate Test (SART). The SART method is described in detail below. It was observed that absorbent articles that contained acquisition fluff pulp of the present invention provided results comparable to those obtained by using commercial cross-linked fiber, especially those cross-linked with polycarboxylic acids. In particular, acquisition fluff pulp cross-linked in fluff form showed superior performance compared to those obtained by using commercial cross-linked fiber, especially those cross-linked with polycarboxylic acids.

The term “absorbent core” as used herein refers to a matrix of cellulosic wood fiber pulp that is capable of absorbing large quantities of fluid. Absorbent cores can be designed in a variety of ways to enhance fluid absorption and retention properties. By way of example, the fluid retention characteristics of absorbent cores can be greatly enhanced by disposing superabsorbent materials amongst fibers of the wood pulp. The absorbent core may be used to manufacture consumer products such as diapers, feminine hygiene products or incontinence products.

Superabsorbent materials are well-known to those skilled in the art as substantially water-insoluble, absorbent polymeric compositions that are capable of absorbing large amounts of fluid ((0.9% solution of NaCl in water) and/or blood) in relation to their weight and forming hydrogel upon such absorption. The terms “superabsorbent polymer” or “SAP” as used herein refer to a polymeric material that is capable of absorbing large quantities of fluid by forming a hydrated gel. The superabsorbent polymers also can retain significant amounts of water under moderate pressures. Superabsorbent polymers generally fall into three classes, namely, starch graft copolymers, cross-linked carboxymethylcellulose derivatives, and modified hydrophilic polyacrylates. Examples of superabsorbent polymers include a hydrolyzed starch-acrylonitrile graft copolymer, a neutralized starch-acrylic acid graft copolymer, a saponified acrylic acid ester-vinyl acetate copolymer, a hydrolyzed acrylonitrile copolymer or acrylamide copolymer, a modified cross-linked polyvinyl alcohol, a neutralized self-cross-linking polyacrylic acid, a cross-linked polyacrylate salt, carboxylated cellulose, and a neutralized cross-linked isobutylene-maleic anhydride copolymer. An absorbent core of the present invention may comprise any SAP known in the art. The SAP can be in the form of particulate matter, flakes, fibers and the like. Exemplary particulate forms include granules, pulverized particles, spheres, aggregates and agglomerates. Exemplary and preferred superabsorbent materials include salts of crosslinked polyacrylic acid such as sodium polyacrylate.

As noted previously, the acquisition fluff pulp of the present invention has high resiliency, high free swell capacity, high absorbent capacity, high absorbency under load, and low third insult strikethrough times. Accordingly, the acquisition fluff pulp of the present invention can be used in combination with SAP and conventional fiber to prepare an absorbent composite (or core) having improved porosity, bulk, resiliency, wicking, softness, absorbent capacity, absorbency under load, low third insult strikethrough, centrifuge retention capacity, and the like. The absorbent composite could be used as an absorbent core of an absorbent article intended for body waste management.

It is preferred in the present invention that the acquisition fluff pulp is present in the absorbent core or composite in an amount ranging from about 10% to about 80% by weight, based on the total weight of the core or composite. More preferably, the acquisition fluff pulp is present in an absorbent core from about 20% to about 60% by weight.

The absorbent core or composite may comprise one or more layers which may comprise acquisition fluff pulp. In one embodiment, one or more layers of the absorbent core comprise a mixture of acquisition fluff pulp with conventional cellulosic fibers and SAP. Preferably, the acquisition fluff pulp of the present invention is present in the fiber mixture in an amount ranging from about 1% to 70% by weight, based on the total weight of the fiber mixture, and more preferably present in an amount ranging from about 10% to about 40% by weight. Any conventional cellulosic fiber may be used in combination with the acquisition fluff pulp of the invention. Suitable conventional cellulosic fibers include any of the wood fibers mentioned previously herein, including caustic-treated fibers, rayon, cotton linters, and mixtures and combinations thereof.

In one embodiment of the invention, the absorbent core may have an upper layer comprising acquisition fluff pulp, and a lower layer comprising a composite of cellulosic fibers and superabsorbent polymer. In this embodiment, the upper layer has a basis weight of about 40 gsm to about 400 gsm. The upper layer and the lower layer of the absorbent core may have the same overall length and/or the same overall width. Alternately, the upper layer may have a length that is longer or shorter than the length of the lower layer. Preferably, the length of the upper layer is 120% to 300% the length of the lower layer. The upper layer may have a width that is wider or narrower than the width of the lower layer. Preferably, the width of the upper layer is 80% the width of the lower layer.

Each layer of the absorbent core may comprise a homogeneous composition, where the acquisition fluff pulp is uniformly dispersed throughout the layer. Alternately, the acquisition fluff pulp may be concentrated in one or more areas of an absorbent core layer. In one embodiment of the present invention, the single layer absorbent core contains a surface-rich layer of the acquisition fluff pulp. Preferably, the surface-rich layer has a basis weight of about 40 gsm to about 400 gsm. Preferably, the surface-rich layer has an area that is about 30% to about 70% of the total area of the absorbent core.

An absorbent core made in accordance with the present invention preferably contains SAP in an amount of from about 20% to about 60% by weight, based on the total weight of the composite, and more preferably from about 30% to about 60% by weight, based on the total weight of the composite. The absorbent polymer may be distributed throughout an absorbent composite within the voids in the fiber. In another embodiment, the superabsorbent polymer may attached to acquisition fluff pulp via a binding agent that includes, for example, a material capable of attaching the SAP to the fiber via hydrogen bonding, (see, for example, U.S. Pat. No. 5,614,570, the disclosure of which is incorporated by reference herein in its entirety).

A method of making an absorbent composite may include forming a pad of acquisition fluff pulp or a mixture of acquisition fluff pulp and other fiber, and incorporating particles of superabsorbent polymer in the pad. The pad can be wet laid or airlaid. Preferably the pad is airlaid. It also is preferred that the SAP and acquisition fluff pulp, or a mixture of acquisition fluff pulp and cellulosic fiber are air-laid together.

An absorbent core containing acquisition fluff pulp and superabsorbent polymer preferably has a dry density of between about 0.1 g/cm³ and 0.50 g/cm³, and more preferably from about 0.2 g/cm³ to 0.4 g/cm³. The absorbent core can be incorporated into a variety of absorbent articles, preferably those articles intended for body waste management, such as diapers, training pants, adult incontinence products, feminine care products, and toweling (wet and dry wipes).

In order that various embodiments of the present invention may be more fully understood, the invention will be illustrated, but not limited, by the following examples. No specific details contained therein should be understood as a limitation to the present invention except insofar as may appear in the appended claims.

Test Methods:

Fiber Quality

Fiber quality evaluations were carried out on a Fluff Fiberization Measuring Instrument (Model 9010, Johnson Manufacturing, Inc., Appleton, Wis., USA). The Fluff Fiberization Measuring Instrument is used to measure knots, nits and fine contents of fibers. In this test, a sample of fiber in fluff form was continuously dispersed in an air stream. During dispersion, loose fibers passed through a 16 mesh screen (1.18 mm) and then through a 42 mesh (0.36 mm) screen. Pulp bundles that remained in the dispersion chamber (called “knots”) and those that were trapped on the 42-mesh screen (called “accepts”) were removed and weighed. The combined weight of these two were subtracted from the original weight of the fluff sample to determine the weight of fibers that passed through the 0.36 mm screen (called “fines.”)

ISO Brightness

ISO Brightness evaluations were carried out on various samples of the acquisition fluff pulp of the present invention, using TAPPI test methods T272 and T525. Selected samples of the acquisition fluff pulp in sheet form were defiberized by feeding them through a hammermill, and then about 3.0 g of the defiberized fluff was airlaid into a circular test sample having approximately a 60 mm diameter. The produced samples were then evaluated for ISO brightness.

The Absorbency Test Method

The absorbency test method was used to determine the absorbency under load, absorbent capacity, and centrifuge retention capacity of acquisition fluff pulp of the present invention. The absorbency test was carried as follows: The test was performed using a plastic cylinder with one inch inside diameter having a 100-mesh metal screen attached to the base of the cylinder. Into the cylinder was inserted a plastic spacer disk having a 0.995 inch diameter and a weighs about 4.4 g. The weight of the cylinder assembly was determined to the nearest 0.001 g (W₀), and then the spacer was removed from the cylinder and about 0.35 g (dry weight basis) of acquisition fluff pulp was air-laid into the cylinder. The spacer disk then was inserted back into the cylinder on the air-laid fibers, and the cylinder assembly was weighed to the nearest 0.001 g (W₁). Fibers in the cell were compressed with a load of 4.0 psi for 60 seconds, the load then was removed and the fiber pad was allowed to equilibrate for 60 seconds. The pad thickness was measured, and the result was used to calculate the dry bulk of acquisition fluff pulp.

A load of 0.3 psi then was placed on the spacer over the fiber pad and the pad was allowed to equilibrate for 60 seconds, after which the pad thickness was measured, and the result was used to calculate the dry bulk under load of the cellulosic based acquisition fibers. The cell and its contents then were hanged in a Petri dish containing sufficient amount of saline solution (0.9% by weight NaCl) to touch the bottom of the cell and the fiber was allowed to stay in contact with the saline solution for 10 minutes. Then it was removed and hanged in another empty Petri dish and allowed to drain for one minute. The load was removed and the weight of the cell and contents was determined (W₂). The weight of the saline solution absorbed per gram fibers then was calculated according to Equation (1) below, the result of which was expressed as the “absorbency under load” (g/g).

$$\frac{{W}_{2} - {W}_{1}}{{W}_{1} - {W}_{0}} \qquad ( 1 )$$

The absorbent capacity of the acquisition fluff pulp was determined in the same manner except that the experiment was carried under zero load. The results were used to determine the weight of the saline solution absorbed per gram fiber and expressed as the “absorbent capacity” (g/g).

The cell then was centrifuged for 3 minutes at 1400 rpm (Centrifuge Model HN, International Equipment Co., Needham HTS, USA), and the weight of the cell and contents is reported (W₃). The centrifuge retention capacity was then calculated according to Equation (2) below, the result of which was expressed as the “centrifuge retention capacity” (g/g).

$$\frac{{W}_{3} - {W}_{0}}{{W}_{1} - {W}_{0}} \qquad ( 2 )$$

Specific Absorption Rate Test (SART)

The SART test method evaluates the performance of an acquisition layer in an absorbent article. To evaluate the acquisition properties, the acquisition time is measured, which is the time required for a dose of saline to be absorbed completely into an absorbent article.

Test samples in the SART test method are comprised of two layers: an acquisition layer and a core layer. In this test, a standard absorbent core was selected as a core sample for all test samples. An airlaid pad made from the test fibers of the present invention was used as an acquisition layer, superimposed on the core sample. The acquisition layer and the core sample were cut into a test sample having a circular shape with a 60 mm diameter. The test sample was placed into a testing apparatus (obtained from Portsmouth Tool and Die Corp., Portsmouth, Va., USA) consisting of a plastic base and a funnel cup. The base is a plastic cylinder having an inside diameter of 60.0 mm that is used to hold the sample. The funnel cup is a plastic cylinder having a hole with a star shape, the outside diameter of which is 58 mm. The test sample was placed inside the plastic base, and the funnel cup was placed inside the plastic base on top of the test sample. A load of about 0.6 psi having a donut shape was placed on top of the funnel cup.

The apparatus and its contents were placed on a leveled surface and the sample was insulted with three successive doses of 9.0 ml of saline solution, (0.9% by weight NaCl), the time interval between doses being 20 minutes. The doses were added with a Master Flex Pump (Cole Parmer Instrument, Barrington, Ill., USA) to the funnel cup. The time (in seconds) required for the saline solution of each dose to disappear from the funnel cup was recorded and expressed as “acquisition time,” or “strikethrough.” The time required for the third dose to disappear was recorded as the “third insult strikethrough time.”

### EXAMPLES

### Example 1

This example illustrates a representative method for making an acquisition fluff pulp of the present invention.

A treatment composition solution was prepared from citric acid (35.0 g) and 1,4-cyclohexanedimethanol (20.0 g) in water (800 mL). The pH was adjusted to about 2.9 to 3.2 with an aqueous solution of NaOH (8.3 g, 50 wt %). After stirring for a few minutes, sodium hypophosphite (8.25 g, 23% by weight of citric acid) was added and the solution was stirred until the sodium hypophosphite was completely dissolved. More water was then added to adjust the concentration of the treatment composition in solution to about 5.5% by weight (final weight of solution is 1.0 kg). The final concentration of polycarboxylic acid in solution was 3.5% by weight.

The produced treatment composition solution then was used to treat the following wood pulps:
(1) “Rayfloc®-J-LD” is an untreated southern pine Kraft pulp commercially available from Rayonier, Inc., for use in applications requiring high absorbency.
“Rayfloc®-J-MX” is a southern pine Kraft pulp partially de-bonded by treatment with quaternary ammonium salt debonder, commercially available from Rayonier, Inc.
“Rayfloc®-J-LD (7% caustic treated)” is a mercerized southern pine Kraft pulp (treated with 7% cold caustic), commercially available from Rayonier, Inc.

Each of the pulp samples treated in this example was in sheet form, having an area of about 12 inch×12 inch and a basis weight of about 680 gsm (g/m²), obtained from jumbo rolls. Each sheet was dipped in the solution of treatment composition prepared above, then pressed to achieve the desired level of treatment composition (100% wet pick-up, about 5.5 weight %=5.5 g of treatment composition per 100 g of fiber). Each sheet was then dried and cured at about 185° C. The curing was carried out in an air driven laboratory oven for about 12 min to produce acquisition fluff pulp. Each acquisition fluff pulp sheet was then defiberized by feeding it through a hammermill (Kamas Mill H01, Kamas Industries AB, Vellinge, Sweden). Absorbent properties and fiber quality of the acquisition fluff pulp samples were then evaluated, the results of which are summarized in Tables 1 and 2 below.

TABLE 1
Absorbent properties of acquisition fluff pulp prepared
with treatment composition of Example 1

| Acquisition | | Absorbent | Absorbency | Centrifuge |
|---|---|---|---|---|
| Fluff Pulp | | Capacity | Under Load | Retention |
| Sample | Base Fiber | (g/g OD) | (g/g OD) | (g/g OD) |
| A | Rayfloc ® -J-LD | 10.5 | 8.9 | 0.50 |
| B | Rayfloc ® -J-LD¹ | 11.0 | 9.6 | 0.57 |
| C | Rayfloc ® -J-MX | 9.8 | 7.5 | 0.53 |
| D | Rayfloc ® -J-LD | 9.5 | 8.1 | 0.57 |
| | (7% caustic | | | |
| | treated) | | | |

¹To produce Sample B, 1 wt % of CHDM was used, and curing was conducted at 195° C. for 10 minutes.

TABLE 2
Fiber quality of commercial fibers and acquisition fluff
pulp prepared using treatment composition of Example 1

| Sample | Knots and nits (%) | Fines (%) |
|---|---|---|
| Rayfloc ® -J-LD (untreated) | 6.2 | 5.1 |
| P&G (Pampers ® AL)¹ | 29.0 | 4.0 |
| Rayfloc ® -J-LD² (no modifying agent) | 58.0 | 7.4 |
| Rayfloc ® -J-LD³ (DP-60 cross-linking | 44.4 | 8.5 |
| agent, no modifying agent) | | |
| A | 24.0 | 7.1 |
| B | 12.9 | 6.6 |
| C | 14.0 | 9.0 |
| D | 1.1 | 6.8 |

¹Extracted from the acquisition layer in the Pampers ® Baby Dry product, produced by Procter & Gamble Company, Cincinnati, OH. This acquisition layer is representative of commercially-available individualized cross-linked cellulose fiber.
²Cross-linked according to Example 1 (with citric acid 3.5 wt %), but no modifying agent was added.
³Prepared as shown in Example 1 except that Belclene ® DP60 was used as a cross-linking agent, and no 1,4-CHDM was used. (Belclene ® DP-60 is a mixture of polymaleic acid terpolymer with the maleic acid monomeric unit predominating (molecular weight of about 1000) and citric acid sold by BioLab Industrial Water Additives Division).

The results in Table 2 demonstrate that samples treated with a treatment solution containing 1-4-CHDM had significantly lower knots and nits as compared to samples cross-linked without 1,4-CHDM and commercial fibers cross-linked in individualized form.

### Example 2

This example illustrates the effect of using treatment compositions prepared using citric acid with various modifying agents, on absorbent properties of representative acquisition fluff pulp formed in accordance with the present invention.

Three treatment composition solutions were prepared in accordance with the method described in Example 1. Each solution contained a citric acid cross-linking agent (3.5% by weight) and a modifying agent (2.0% by weight). The first treatment composition contained a 1,4-cyclohexanoldimethanol modifying agent; the second treatment composition contained a tri(propylene glycol) methyl ether modifying agent, and the third treatment composition contained a tri(propylene glycol) modifying agent. Each treatment composition solution was used to treat a sample of Rayfloc®-J-LD fibers, using the method described in Example 1. The treated fiber samples were cured and dried at 185° C. for about 12 minutes to produce acquisition fluff pulp samples. The samples were subsequently defiberized, using the method described in Example 1. Absorbent properties of the acquisition fluff pulps were then evaluated, the results of which are presented in Table 3.

TABLE 3
Absorbent properties of acquisition fluff pulp prepared
using citric acid and various modifying agents

| Composition of Treatment | | | | |
|---|---|---|---|---|
| Composition | | Absorbent | Absorbency | Centrifuge |
| Cross-linking | Modifying | Capacity (0.3 psi) | Under Load | Retention |
| Agent | Agent ¹ | (g/g OD) | (g/g OD) | (g/g OD) |
| Citric acid | CHDM | 10.5 | 8.9 | 0.50 |
| Citric acid | TPGME | 10.7 | 8.6 | 0.48 |
| Citric acid | TPG | 7.7 | 9.5 | 0.51 |

¹ Modifying Agents:
CHDM = 1,4-cyclohexanoldimethanol.
TPGME = Tri(propylene glycol) methyl ether.
NPGDGE = Tri(propylene glycol).

### Example 3

This example illustrates the effect of using treatment compositions prepared using various polycarboxylic acids in addition to the CHDM modifying agent, on fiber quality and absorbent properties of acquisition fluff pulp formed in accordance with the present invention.

Three treatment composition solutions were prepared in accordance with the method described in Example 1, each solution containing a different mixture of polycarboxylic acids as shown in Table 4 below. All solutions contain 1% by weight of modifying agent CHDM, and catalyst NaH₂PO₂ (about 33.3% by weight of polycarboxylic acid). Each treatment composition solution was used to treat a sample of Rayfloc®-J-LD fibers, using the method described in Example 1. The treated fiber samples were cured and dried at 195° C. for about 10 minutes to produce acquisition fluff pulp samples. The samples were subsequently defiberized, using the method described in Example 1. Absorbent properties, fiber quality and ISO Brightness of the acquisition fluff pulps were then evaluated and compared to commercially-available fibers, the results of which are presented in Tables 4 and 5 below.

TABLE 4
Absorbent properties of acquisition fluff pulp, prepared
using treatment compositions of Example 3

| Acquisition | Treatment | Absorbent | Absorbency | Centrifuge |
|---|---|---|---|---|
| Fluff Pulp | Composition | Capacity | Under Load | Retention |
| Sample | Solution¹ | (g/g OD) | (g/g OD) | (g/g OD) |
| E | Citric acid (2.8%), | 10.9 | 9.5 | 0.54 |
| | Polymaleic acid² | | | |
| | (0.7%) | | | |
| F | Citric acid (2.8%), | 10.3 | 8.8 | 0.56 |
| | Polyacrylic acid³ | | | |
| | (0.7%) | | | |
| G | Citric acid (4.0%) | 10.2 | 8.6 | 0.53 |

¹All solutions contain 1% of modifying agent CHDM.
²Provided as an aqueous solution of polymaleic acid homopolymer with a molecular weight of about 800. (Commercially available as Belclene ® 200, from BioLab Industrial Water Additives Division, Decatur, GA.)
³Provided as an aqueous solution of polyacrylic homopolymer with a molecular weight of about 2250. (Commercially available as Criterion ® 2000, from Kemira Chemical Company, Marietta, GA.)

TABLE 5
Fiber quality of commercial fibers and acquisition fluff
pulp, prepared using treatment compositions of Example 3

| | Knots and | | |
|---|---|---|---|
| Sample | nits (%) | Fines (%) | ISO Brightness |
| Rayfloc ® -J-LD¹ | 6.2 | 5.1 | 86.0 |
| (untreated) | | | |
| P&G (Pampers ® | 29.0 | 4.0 | 75.0 |
| Cruiser)² | | | |
| E | 14.0 | 7.2 | 77.8 |
| F | 10.9 | 5.1 | 80.2 |
| G | 18.9 | 6.2 | 78.7 |

¹Untreated conventional pulp.
²Extracted from the acquisition layer in the Pampers ® Cruiser (stage 4) product, produced by Procter & Gamble Company, Cincinnati, OH. This acquisition layer is representative of commercially-available individualized cross-linked cellulose fiber.

The results of Table 5 reveal that the acquisition fluff pulps produced in accordance with the present invention provide improved fiber quality and ISO Brightness as compared to commercially-available fibers.

### Example 4

This example shows the effect of using treatment composition solution with various concentrations of catalyst on absorbent properties and fiber qualities of acquisition fluff pulp of the present invention.

Four treatment composition solutions were prepared in accordance with the method of Example 1, each containing citric acid (2.8% by weight), polymaleic acid (0.7% by weight), 1,4-CHDM (1% by weight), and different concentrations of a catalyst (NaH₂PO₂) as shown below in Table 6. Each treatment composition was used to treat a sheet of Rayfloc®-J-LD wood pulp, using the method described in Example 1. The treated sheets were dried and cured at 195° C. for about 10 minutes to produce acquisition fluff pulp samples in sheet form. The samples were subsequently defiberized, using the method described in Example 1. The absorbent properties, fiber quality and ISO Brightness of the acquisition fluff pulp samples were evaluated, the results of which are presented in Tables 6 and 7 below.

TABLE 6
Absorbent properties of acquisition fluff pulp, prepared using treatment
compositions of Example 4 with various amount of catalyst

| | Weight Ratio of | | | |
|---|---|---|---|---|
| Acquisition | Catalyst to | Absorbent | Absorbency | Centrifuge |
| Fluff Pulp | Polycarboxylic | Capacity | Under Load | Retention |
| Sample | Acid | (g/g OD) | (g/g OD) | (g/g OD) |
| H | 1:6 | 11.0 | 9.0 | 0.57 |
| I | 1:4 | 10.2 | 8.6 | 0.55 |
| J | 1:3 | 10.9 | 9.5 | 0.54 |
| K | 1:2 | 11.6 | 9.5 | 0.53 |

TABLE 7
Fiber quality of acquisition fluff pulp, prepared
using treatment compositions of Example 4

| Acquisition Fluff | Knots and | | ISO |
|---|---|---|---|
| Pulp Sample | nits (%) | Fines (%) | Brightness |
| H | 15.7 | 6.6 | 78.1 |
| I | 12.2 | 6.4 | 79.5 |
| J | 10.9 | 5.1 | 79.0 |
| K | 12.7 | 6.3 | 80.6 |

Tables 6 and 7 show that increasing the amount of catalyst has a slight impact on the absorbent properties and on fiber quality of acquisition fluff pulp of the present invention.

### Example 5

This example illustrates the effect of varying curing time and temperature on absorbent properties of representative acquisition fluff pulp formed in accordance with the present invention.

The treatment composition solution of Example 4 is produced with a NaH₂PO₂ catalyst (about 50 weight % based on weight of polycarboxylic acid). This treatment solution was used to treat sheets of Rayfloc®-J-LD wood pulp, using the method described in Example 1. Each treated pulp sample was cured using different temperature and time parameters to produce an acquisition fluff pulp sample. The samples were subsequently defiberized, using the method described in Example 1. The absorbent properties of each acquisition fluff pulp sample were evaluated, the results of which are presented in Table 8 below.

TABLE 8
The effect of curing temperature and time on absorbent
properties of acquisition fluff pulp using composition
with high concentration of catalyst

| Curing | Curing | Absorbent | Absorbency | Centrifuge | Knots and |
|---|---|---|---|---|---|
| Temperature | Time | Capacity | Under Load | Retention | nits |
| (° C.) | (min) | (g/g OD) | (g/g OD) | (g/g OD) | (wt %) |
| 170 | 12 | 10.7 | 9.3 | 0.58 | 8.6 |
| 170 | 15 | 10.8 | 9.0 | 0.56 | 10.9 |
| 185 | 12 | 10.8 | 9.2 | 0.54 | 23.0 |
| 185 | 10 | 10.1 | 8.5 | 0.54 | 14.0 |
| 195 | 12 | 10.3 | 8.7 | 0.54 | 24.0 |
| 195 | 11 | 10.1 | 8.5 | 0.53 | 19.8 |
| 195 | 10 | 10.1 | 8.4 | 0.53 | 13.0 |
| 195 | 8 | 9.9 | 8.3 | 0.64 | 4.2 |

The results in Table 8 clearly show that a curing temperature of 185° C. or greater is required to induce an effective bond between the treatment composition of the present invention and wood fluff pulp. Table 8 also demonstrates that a long curing time has a low to medium effect on the absorbent properties of acquisition fluff pulp, while it has a negative impact on fiber quality. For example, at a curing temperature of 195° C., increasing the curing time from 10 to 12 minutes causes the fiber contents of knots and nits to almost double.

### Example 6

The acquisition fluff pulp made in accordance with an embodiment of the present invention was tested for liquid acquisition properties. To evaluate the acquisition properties, the third insult acquisition time, or strikethrough was measured, which is the time required for a third consecutive dose of saline to be absorbed completely into an absorbent article, using the SART test method described above.

Five test samples were produced for testing purposes. Each sample contained an absorbent core layer and an acquisition layer, cut into a circular shape having a diameter of 60 mm. The absorbent core layer in each sample was comprised of a commercially available absorbent material (NovaThin®, from Rayonier, Inc.), having a basis weight of about 850 gsm and containing about 40% SAP by weight. Each core layer weighed about 2.6 g (±0.2 g). Acquisition layers were produced from airlaid pads of the acquisition fluff pulp samples produced in Example 3, as shown below in Table 9. A control sample was produced having an airlaid acquisition layer comprising conventional Rayfloc J-LD pulp fiber. A commercial sample was produced having an acquisition layer extracted from a Pampers Baby Dry product (made by Procter & Gamble Co.). Each acquisition layer consisted of a 0.7 g air-laid pad compacted to a thickness of about 3.0 to 3.4 mm before it was used.

The test samples were insulted with three doses of saline (0.9% by weight NaCl), according to the method described in the SART test method above. The third insult strikethrough time for each test sample was recorded, and is provided in Table 9 below.

TABLE 9
Liquid acquisition time for absorbent articles containing representative
acquisition fluff pulps and commercial fibers

| | 3^{rd} Insult |
|---|---|
| | Strikethrough |
| Sample | (sec) |
| Rayfloc ® -J-LD | >45 |
| (untreated) | |
| P&G (Pampers ® Cruiser)¹ | 5.2 |
| E | 6.5 |
| F | 7.1 |
| G | 6.3 |

¹Extracted from the acquisition layer in the Pampers ® Cruiser (stage 4) product, produced by Procter & Gamble Company, Cincinnati, OH. This acquisition layer is representative of commercially-available individualized cross-linked cellulose fiber

The results in Table 9 show that the acquisition fluff pulp of the present invention has a significantly lower acquisition time as compared to conventional untreated fluff pulp. In addition, the acquisition fluff pulp of the present invention prepared in sheet form has almost equal performance to commercial cross-linked fibers that have been cross-linked in individualized form. This demonstrates that using a treatment composition solution that has 1,4-CHDM has no negative impact on acquisition properties of acquisition fluff pulp of the present invention.

### Example 7

The acquisition fluff pulp made in accordance with various embodiments of the present invention was evaluated for acquisition and rewet properties. The acquisition and rewet test measures the rate of absorption of multiple fluid insults to an absorbent product and the amount of fluid which can be detected on the surface of the absorbent structure after its saturation with a given amount of saline while the structure is placed under a load of 0.5 psi. This method is suitable for all types of absorbent materials, especially those intended for urine-absorption applications.

Acquisition and rewet for acquisition fluff pulp of the present invention were determined using standard procedures well known in the art. Test samples were prepared from an absorbent core layer (taken from a Pampers® Cruiser®, Stage 4), superposed with an acquisition layer prepared from an airlaid pad of acquisition fluff pulp fibers of the present invention (prepared in accordance with Example 3). The test samples were prepared as 40 cm×12 cm panels. Initially, the dry weight of a test sample was recorded. Then the sample was insulted with an 80 mL, fixed volume amount of saline solution (0.9% by weight NaCl), through a fluid delivery column at a 1 inch diameter impact zone under a 0.1 psi load. The time (in seconds) for the entire 80 mL of solution to be absorbed was recorded as the “acquisition time.” Then the test sample was left undisturbed for a 30 minute waiting period. A previously weighed a stack of filter paper (e.g., 15 sheets of Whatman #4 (70 mm)) was placed over the insult point on the test sample, and a 0.5 psi load (2.5 kg) was then placed on top of the stack of filter papers on the test sample for 2 minutes. The wet filter papers were then removed, and the wet weight was recorded. The difference between the initial dry weight of the filter papers and final wet weight of the filter papers was recorded as the “rewet value” of the test specimen. This entire test was repeated 2 more times on the same wet test specimen and in the same position as before. Each acquisition time and rewet value was reported along with the average and the standard deviation. The “acquisition rate” was determined by dividing the 80 mL volume of liquid used by the acquisition time previously recorded. For any specimen having one embossed side, the embossed side is the side initially subjected to the test fluid. All results are summarized in Table 10 below.

TABLE 10
Acquisition and Rewet for absorbent articles¹ with acquisition layers
comprised of acquisition fluff pulps of the present invention

| | Rate | Rate | Rate | | | |
|---|---|---|---|---|---|---|
| Sample | of 1^{st} | of 2^{nd} | of 3^{rd} | Rewet | Rewet | Rewet |
| (Acquisition | insult | insult | insult | 1^{st} (g | 2^{nd} (g | 3^{rd} (g |
| Layer) | (ml/sec) | (ml/sec) | (ml/sec) | saline) | saline) | saline) |
| Control ² | 4.7 | 3.6 | 2.5 | 0.07 | 0.05 | 0.06 |
| E | 5.3 | 6.0 | 3.7 | 0.04 | 0.05 | 0.09 |
| F | 6.4 | 5.6 | 4.5 | 0.04 | 0.05 | 0.06 |
| G | 6.1 | 6.4 | 3.8 | 0.05 | 0.06 | 0.06 |

¹The core for each sample was obtained from Pampers ® Cruiser diaper (stage 4), produced by Procter & Gamble Company, Cincinnati, OH.
² No acquisition layer was used in the control sample.

The results in Table 10 demonstrate that acquisition fluff pulps of the present invention prepared in sheet form have significantly lower acquisition rates when compared to a control without an acquisition layer.

While the invention has been described with reference to particularly preferred embodiments and examples, those skilled in the art recognize that various modifications may be made to the invention without departing from the spirit and scope thereof.

1. A treatment composition for making acquisition fluff pulp, comprising a mixture of a cross-linking agent and a modifying agent.

2. The treatment composition of claim 1, wherein the cross-linking agent is a polycarboxylic acid.

3. The treatment composition of claim 1, wherein the cross-linking agent is an aldehyde.

4. The treatment composition of claim 1, wherein the cross-linking agent is a urea-based derivative.

5. The treatment composition of claim 1, wherein the cross-linking agent and the modifying agent are mixed in a weight ratio of from about 1:1 to about 6:1 of cross-linking agent to modifying agent.

6. The treatment composition of claim 2, wherein the polycarboxylic acid comprises at least two acid functional groups.

7. The treatment composition of claim 2, wherein the polycarboxylic acid is an alkanepolycarboxylic acid.

8. The treatment composition of claim 7, wherein the alkanepolycarboxylic acid is selected from the group consisting of: 1,2,3,4-butanetetracarboxylic acid, 1,2,3-propanetricarboxylic acid, oxydisuccinic acid, citric acid, itaconic acid, maleic acid, tartaric acid, glutaric acid, iminodiacetic acid, citraconic acid, tartarate monsuccininc acid, benzene hexacarboxylic acid, cyclohexanehexacarboxylic acid, and mixtures and combinations thereof.

9. The treatment composition of claim 2, wherein the polycarboxylic acid is a polymeric polycarboxylic acid.

10. The treatment composition of claim 9, wherein the polymeric polycarboxylic acid is a polymer or copolymer prepared from one or more monomers selected from the group consisting of: acrylic acid, vinyl acetate, maleic acid, maleic anhydride, carboxy ethyl acrylate, itanoic acid, fumaric acid, methacrylic acid, crotonic acid, aconitic acid, acrylic acid ester, methacrylic acid ester, acrylic amide, methacrylic amid, butadiene, styrene, and combinations and mixtures thereof.

11. The treatment composition of claim 3, wherein the aldehyde cross-linking agent is selected from the group consisting of: formaldehyde, glyoxal, glutaraldehyde, glyceraldehydes, and combinations and mixtures thereof.

12. The treatment composition of claim 4, wherein the urea-based derivative cross-linking agent is selected from the group consisting of: urea based-formaldehyde addition products, methylolated ureas, methylolated cyclic ureas, methylolated lower alkyl cyclic ureas, methylolated dihydroxy cyclic ureas, dihydroxy cyclic ureas, lower alkyl substituted cyclic ureas, dimethyldihydroxy urea (1,3-dimethyl-4,5-dihydroxy-2-imidazolidinone), dimethyloldihydroxyethylene urea (1,3-dihydroxymethyl-4,5-dihydroxy-2-imidazolidinone), dimethylol urea (bis[N-hydroxymethyl]urea), dihydroxyethylene urea (4,5-dihydroxy-2-imidazolidinone), dimethylolethylene urea (1,3-dihydroxymethyl-2-imidazolidinone), dimethyldihydroxyethylene urea (4,5-dihydroxy-1,3-dimethyl-2-imidazolidinone), glyoxal adducts of urea, polyhydroxyalkyl urea, hydroxyalkyl urea, β-hydroxyalkyl amide, and combinations and mixtures thereof.

13. The treatment composition of claim 1, wherein the modifying agent is selected from the group consisting of: polyhydroxy compounds containing hydrophobic alkyl group; ether derivatives of polyhodroxy compounds containing hydrophobic alkyl group; ester derivatives of polyhydroxy compounds containing hydrophobic alkyl group; and combinations and mixtures thereof;
wherein the hydrophobic alkyl group is an alkyl with 3 or more carbon atoms comprised of saturated, unsaturated (alkenyl, alkynyl, allyl), substituted, un-substituted, branched and un-branched, cyclic, or acyclic compounds.

14. The treatment composition of claim 13, wherein the modifying agent is selected from the group consisting of: cyclohexanedimethanol, diacetin, tri(propylene glycol), di(propylene glycol), tri(propylene glycol) methyl ether, tri(propylene glycol) butyl ether, tri(propylene glycol) propyl ether, di(propylene glycol) methyl ether, di(propylene glycol) butyl ether, di(propylene glycol) propylether, di(propylene glycol) dimethyl ether, 2-phenoxyethanol, propylene carbonate, propyleneglycol diacetate, and combinations and mixtures thereof.

15. A method of making acquisition fluff pulp comprising:
providing a treatment composition solution comprising the treatment composition of claim 1,
providing cellulosic base fiber,
applying the treatment composition solution to the cellulosic base fiber to impregnate the cellulosic base fiber with the treatment composition,
drying and curing the impregnated cellulosic fiber to form intra-fiber bonds.

16. The method of claim 15, wherein the treatment composition solution has a pH of about 1.5 to about 5.0.

17. The method of claim 15, wherein the treatment composition solution has a pH of about 1.5 to about 3.5.

18. The method of claim 15, wherein applying the treatment composition solution to cellulosic base fiber comprises spraying, dipping, rolling, or applying with a puddle press, size press or a blade-coater.

19. The method of claim 15, wherein the cellulosic base fiber is provided in sheet form.

20. The method of claim 15, wherein the cellulosic base fiber is provided in fluff form.

21. The method of claim 15 wherein the cellulosic base fiber is provided in non-woven mat form.

22. The method of claim 18, wherein the treatment composition solution has a concentration of treatment composition within the range of from about 3.5 weight % to about 7.0 weight %, based on the total weight of the solution.

23. The method of claim 15, wherein the treatment composition solution is applied to the cellulosic based fiber to provide about 10% to about 150% by weight of solution on fiber, based on the total weight of the fiber.

24. The method of claim 15, wherein the treatment composition solution is applied to the cellulosic base fiber to provide about 2% to about 7% by weight of treatment composition on fiber, based on the total weight of the fiber.

25. The method of claim 15, wherein the treatment composition solution is applied to the cellulosic base fiber to provide about 3% to about 6% by weight of treatment composition on fiber, based on the total weight of the fiber.

26. The method of claim 15, wherein the treatment composition solution further comprises a catalyst to accelerate the formation of an ester link between a hydroxyl group of the cellulosic fiber and a carboxyl group of the cross-linking agent.

27. The method of claim 26, wherein the catalyst is an alkali metal salt of phosphorous containing an acid selected from the group consisting of: alkali metal hypophosphites, alkali metal phosphites, alkali metal polyphosphonates, alkali metal phosphates, alkali metal sulfonates, and combinations and mixtures thereof.

28. The method of claim 15, wherein the cellulosic base fiber is provided in a dry state.

29. The method of claim 15, wherein the cellulosic base fiber is provided in a wet state.

30. The method of claim 15, wherein the cellulosic base fiber is a conventional cellulose fiber.

31. The method of claim 30, wherein the conventional cellulose fiber is a wood pulp fiber obtained from a Kraft or sulfite chemical process.

32. The method of claim 31, wherein the wood pulp fiber is obtained from a hardwood cellulose pulp, a softwood cellulose pulp, or a combination or mixture thereof.

33. The method of claim 32, wherein the hardwood cellulose pulp is selected from the group consisting of: gum, maple, oak, eucalyptus, poplar, beech, aspen, and combinations and mixtures thereof.

34. The method of claim 32, wherein the soft cellulose pulp is selected from the group consisting of: Southern pine, White pine, Caribbean pine, Western hemlock, spruce, Douglas fir, and mixtures and combinations thereof.

35. The method of claim 30, wherein the conventional cellulose fiber is derived from cotton linters, bagasse, kemp, flax, grass, or combinations or mixtures thereof.

36. The method of claim 15, wherein the cellulosic base fiber is a caustic-treated fiber.

37. The method of claim 36, wherein the caustic-treated fiber is prepared by treating a liquid suspension of pulp at a temperature of from about 5° C. to about 85° C. with an aqueous alkali metal salt solution for a period of time ranging from about 5 minutes to about 60 minutes;
wherein said aqueous alkali metal salt solution has an alkali metal salt concentration of about 2 weight % to about 25 weight %, based on the total weight of said solution.

38. The method of claim 15, wherein the cellulosic base fiber is non-bleached, partially bleached or fully bleached cellulosic fibers.

39. The method of claim 15, wherein the drying and curing occurs in a one-step process.

40. The method of claim 15, wherein the drying and curing is conducted at a temperature within the range of about 130° C. to about 225° C.

41. The method of claim 15, wherein the drying and curing is conducted for about 3 minutes to about 15 minutes at temperatures within the range of about 130° C. to about 225° C.

42. The method of claim 15, wherein the drying and curing occurs in a two-step process.

43. The method of claim 42, wherein the drying and curing comprises:
first drying the impregnated cellulosic fiber, and curing the dried cellulosic fiber to form intra-fiber bonds.

44. The method of claim 42, wherein the drying and curing comprises:
drying the impregnated cellulosic fiber at a temperature below curing temperature, and
curing the dried impregnated cellulosic fiber for about 1 to 10 minutes at a temperature within the range of about 150° C. to about 225° C.

45. The method of claim 42, wherein the drying and curing comprises:
drying the impregnated cellulosic fiber at a temperature within the range of about room temperature to about 130° C., and curing the dried impregnated cellulosic fiber for about 0.5 to about 5 minutes at a temperature within the range of about 130° C. to about 225° C.

46. Acquisition fluff pulp produced by the method of claim 15.

47. The acquisition fluff pulp of claim 46, whereby the acquisition fluff pulp has a centrifuge retention capacity of less than about 0.6 grams of a 0.9% by weight saline solution per gram of oven dried fiber.

48. The acquisition fluff pulp of claim 46, whereby the acquisition fluff pulp has a centrifuge retention capacity of less than about 0.55 g saline/g OD fiber.

49. The acquisition fluff pulp of claim 46, whereby the acquisition fluff pulp has a centrifuge retention capacity of less than about 0.52 g saline/g OD fiber.

50. The acquisition fluff pulp of claim 46, whereby the acquisition fluff pulp has an absorbent capacity of at least about 8.0 g saline/g OD fiber.

51. The acquisition fluff pulp of claim 46, whereby the acquisition fluff pulp has an absorbent capacity of at least about 9.0 g saline/g OD fiber.

52. The acquisition fluff pulp of claim 46, whereby the acquisition fluff pulp has an absorbent capacity of at least about 10.0 g saline/g OD fiber.

53. The acquisition fluff pulp of claim 46, whereby the acquisition fluff pulp has an absorbent capacity of at least about 11.0 g saline/g OD fiber.

54. The acquisition fluff pulp of claim 46, whereby the acquisition fluff pulp has an absorbency under load of at least about 7.0 g saline/g OD fiber.

55. The acquisition fluff pulp of claim 46, whereby the acquisition fluff pulp has an absorbency under load of at least about 8.5 g saline/g OD fiber.

56. The acquisition fluff pulp of claim 46, whereby the acquisition fluff pulp has an absorbency under load of at least about 9.0 g saline/g OD fiber.

57. The acquisition fluff pulp of claim 46, whereby the acquisition fluff pulp has a dry bulk of at least about 8.0 cm³/g fiber.

58. The acquisition fluff pulp of claim 46, whereby the acquisition fluff pulp has a dry bulk of at least about 9.0 cm³/g fiber.

59. The acquisition fluff pulp of claim 46, whereby the acquisition fluff pulp has a dry bulk of at least about 10.0 cm³/g fiber.

60. The acquisition fluff pulp of claim 46, whereby the acquisition fluff pulp has a dry bulk of at least about 11.0 cm³/g fiber.

61. The acquisition fluff pulp of claim 46, whereby the acquisition fluff pulp after defiberization has knots and nits contents of less than about 25%.

62. The acquisition fluff pulp of claim 46, whereby the acquisition fluff pulp after defiberization has knots and nits contents of less than about 15%.

63. The acquisition fluff pulp of claim 46, whereby the acquisition fluff pulp after defiberization has knots and nits contents of less than about 10%.

64. The acquisition fluff pulp of claim 46, whereby the acquisition fluff pulp after defiberization has a fines content of less than about 10%.

65. The acquisition fluff pulp of claim 46, whereby the acquisition fluff pulp after defiberization has a fines content of less than about 9%.

66. The acquisition fluff pulp of claim 46, whereby the acquisition fluff pulp after defiberization has a fines content of less than about 8%.

67. The acquisition fluff pulp of claim 46, whereby the acquisition fluff pulp after defiberization has fines contents of less than about 7%.

68. The acquisition fluff pulp of claim 46, wherein the fibers have an ISO Brightness of greater than 75%.

69. The acquisition fluff pulp of claim 46, whereby acquisition fluff pulp has a centrifuge retention capacity of less than about 0.55 g saline/g OD fiber and an ISO Brightness of greater than 75%.

70. The acquisition fluff pulp of claim 46, whereby the acquisition fluff pulp after defiberization in a Kamas hammermill provide fibers with greater than 75% accept, wherein the accept has a centrifuge retention capacity of less than about 0.55 g saline/g OD fiber and an ISO Brightness of greater than 75%.

71. An absorbent article comprising the acquisition fluff pulp of claim 46.

72. The absorbent article of claim 71, wherein the absorbent article is at least one article selected from the group consisting of infant diapers, feminine care products, training pants, and adult incontinence briefs.

73. The absorbent article of claim 71, wherein the absorbent article comprises a liquid penetrable top sheet, a liquid impenetrable back sheet, and an absorbent core; wherein the absorbent core is located between the top sheet and the back sheet.

74. The absorbent article of claim 73, wherein the absorbent article additionally comprises an acquisition layer, wherein the acquisition layer is located between the absorbent core and the topsheet.

75. The absorbent article of claim 74, wherein the acquisition layer comprises the acquisition fluff pulp.

76. The absorbent article of claim 73, wherein the absorbent core comprises a composite of superabsorbent polymer and cellulosic fiber.

77. The absorbent article of claim 76, wherein the cellulosic fiber comprises the acquisition fluff pulp.

78. The absorbent article of claim 76, wherein the superabsorbent polymer is selected from the group consisting of polyacrylate polymers, starch graft copolymers, cellulose graft copolymers, cross-linked carboxymethylcellulose derivatives, and mixtures and combinations thereof.

79. The absorbent article of claim 76, wherein the superabsorbent polymer is in the form of fiber, flakes, or granules.

80. The absorbent article of claim 76, wherein the superabsorbent polymer is present in an amount of from about 20% to about 60% by weight, based on the total weight of the absorbent core.

81. The absorbent article of claim 76, wherein the cellulosic fiber comprises a mixture of the acquisition fluff pulp and conventional cellulosic fiber.

82. The absorbent article of claim 81, wherein the conventional cellulosic fiber is a wood pulp fiber selected from the group consisting of hardwood pulp, softwood cellulose pulp obtained from a Kraft or sulfite chemical process, mercerized, rayon, cotton linters, and combinations or mixtures thereof.

83. The absorbent article of claim 77, wherein the acquisition fluff pulp is present in an amount of from about 10% to about 80% by weight, based on the total weight of the absorbent core.

84. The absorbent article of claim 77, wherein the acquisition fluff pulp is present in an amount of from about 20% to about 60% by weight, based on the total weight of the absorbent core.

85. The absorbent article of claim 81, wherein the acquisition fluff pulp is present in the fiber mixture in an amount of from about 1% to about 70% by weight, based on the total weight of the fiber mixture.

86. The absorbent article of claim 81, wherein the acquisition fluff pulp is present in the fiber mixture in an amount of from about 10% to about 40% by weight, based on the total weight of the fiber mixture.

87. The absorbent article of claim 76, wherein the absorbent core is a multi-layer absorbent structure comprising:
an upper layer comprising the acquisition fluff pulp, and
a lower layer comprising a composite of superabsorbent polymer and cellulosic fibers
wherein the upper layer has a basis weight of about 40 gsm to about 400 gsm.

88. The absorbent article of claim 87, wherein the upper layer has a length that is equal to the length of the lower layer.

89. The absorbent article of claim 87, wherein the upper layer has a width that is less than 80% of the width of the lower layer.

90. The absorbent article of claim 87, wherein the upper layer has a length that is 120% to 300% of the length of the lower layer.

91. The absorbent article of claim 73, wherein the absorbent core comprises a single-layer absorbent structure comprising the acquisition fluff pulp; wherein the single-layer absorbent structure has a surface-rich layer of acquisition fluff pulp having a basis weight of about 40 gsm to about 400 gsm.

92. The absorbent article of claim 91, wherein the surface-rich layer has an area that is 30% to 70% of the area of the single-layer absorbent structure.
